(19) United States
(12) Patent Application Publication
(10) Pub. No.: US 2006/0129452 A1
(43) Pub. Date: Jun. 15, 2006

(54) System and method for utilizing a multifaceted entity profile

(75) Inventors: John W. Nordberg, Northbrook, IL (US); Margaret F. Moschetto, San Antonio, TX (US); Sharon R. Martinez, San Ramon, CA (US); Deborah Quintannilla, San Antonio, TX (US)

Correspondence Address: TOLER SCHAFFER, LLP, 5000 PLAZA ON THE LAKES, SUITE 265, AUSTIN, TX, 78746, US

(73) Assignee: SBC Knowledge Ventures, LP

(21) Appl. No.: 11/012,862

(22) Filed: Dec. 15, 2004

(51) Int. Cl. G06Q 30/00

(52) U.S. Cl. 705/14

(57) ABSTRACT

A system and method for utilizing a multifaceted entity profile are disclosed. A method incorporating teachings of the present disclosure may include identifying a first to be profiled entity and inputting a demonstrable characteristic for the first entity into a predefined and multifaceted profile template. The demonstrable characteristic may include, for example, a physical address for the first entity or a Data Universal Numbering System (DUNS) number for the first entity. The method may also include inputting a presumed characteristic for the first entity into the profile template. In some implementations, the presumed characteristic may be somewhat subjective. In practice, a multifaceted profile based at least in part on the demonstrable characteristic and the presumed characteristic may be generated for the first entity, and the multifaceted profile may filtered against a selected criteria to identify a selected approach for dealing with the first entity.

### FIELD OF THE DISCLOSURE

The present disclosure relates to information management, and more particularly to a system and method for utilizing a multifaceted entity profile.

### BACKGROUND OF THE DISCLOSURE

Improved computing systems and storage technologies have helped increase the volume of information available through public and/or private computer networks, databases, and other electronic resources. Interestingly, the growth of available information has not always resulted in a similar increase in the ability to quickly and easily find and utilize desired information.

While information about a given subject may be available somewhere, people desiring the information often need to know where and how to find the information. Frequently, people do not know the information is available. And, even if they do know the information is available, they may find that it is effectively “trapped” by an overly complex information storage schema, by insufficiently interconnected storage resources, or by the sheer volume of available information. As such, there may be little chance of finding or making effective use of desired information without knowledge of the system or systems maintaining the information.

### BRIEF DESCRIPTION OF THE DRAWINGS

It will be appreciated that for simplicity and clarity of illustration, elements illustrated in the Figures have not necessarily been drawn to scale. For example, the dimensions of some of the elements are exaggerated relative to other elements. Embodiments incorporating teachings of the present disclosure are shown and described with respect to the drawings presented herein, in which:

FIG. 1 presents a flow diagram for an embodiment of a multifaceted customer profiling technique that incorporates teachings of the present disclosure;

FIG. 2 presents an illustrative diagram of a user interface system that facilitates the presentation of profile-filtered information in accordance with teachings of the present disclosure; and

FIG. 3 illustrates one embodiment of a display that facilitates the creation and utilization of a customer profile in accordance with teachings of the present disclosure.

### DETAILED DESCRIPTION OF THE DRAWINGS

As mentioned above, many users do not know when useful information is available to them. And, when they do know the information is available, they often find that it is effectively “trapped” by an overly complex information storage schema, by insufficiently interconnected storage resources, or by the sheer volume of available information.

The following discussion focuses on a system and a method for utilizing a multifaceted entity profile to help alleviate some of these traps. Much of the following discussion focuses on how a company may accumulate and make use of customer-related information. In particular, several of the discussed embodiments describe how a large organization can create virtual profiles for current, past, and potential customers. These virtual profiles may then be used in simulations or filtered against different criteria, sales plans, promotions, marketing pushes, etc. to help the organization optimize some of its operations—like those related, for example, to marketing, sales, support services, etc.

While the following discussion may focus, at some level, on this implementation of multifaceted profiles, the teachings disclosed herein have broader application. Although certain embodiments are described using specific examples, it will be apparent to those skilled in the art that the invention is not limited to these few examples. Accordingly, the present invention is not intended to be limited to the specific form set forth herein, but on the contrary, it is intended to cover such alternatives, modifications, and equivalents, as can be reasonably included within the spirit and scope of the disclosure.

From a high level, utilizing a multifaceted entity profile in a manner that incorporates teachings disclosed herein may involve identifying an entity to be profiled. The entity may be, for example, an individual, a group of people, an organization, a company, an animal, a market, and/or some other form having defining characteristics.

Once identified, a multifaceted profile may be created. The profile may be embodied in one or more of several forms, which may include, for example, a spreadsheet, a Business Object compatible format, a Horizon compatible format, a word document, a linked list, a structured database, an HTML page, or a virtual abstraction made up of pointers indicating the location of remotely maintained information. The profile may fit a standard template—including a predefined set of to-be-populated criteria and/or fields. The profile may also have a more custom or one-off format. In practice, a first and second characteristic for a to-be-profiled entity may be input into the profile. The first criteria may represent a demonstrable characteristic. And the second criteria may represent a presumed characteristic.

In practice, a demonstrable characteristic may be something well known and/or easily observable about the entity. If the entity is a person, the demonstrable characteristic may relate to things like name, gender, education level, height, right or left handedness, eye color, hair color, ethnicity, etc. If the entity is a company, the demonstrable characteristic may relate to things like name, location(s), number of employees, Data Universal Numbering System (DUNS), etc.

A presumed characteristic, on the other hand, may be something more difficult to prove. Presumed characteristics may represent opinions, perceptions, observations, educated guesses, etc. In some embodiments, a person creating a multifaceted profile may want to weight a presumed characteristic. If the person is pretty sure the characteristic is accurate, the characteristic may be given a significant weighting. If the presumed characteristic is little more than a wild guess, the person creating the profile may give it a relatively insignificant weighting.

By way of example, if a profiled entity is a person, a presumed characteristic may relate to things like favorite color, favorite sport, eating habits, likes, dislikes, etc. If a profiled entity is a company, a presumed characteristic may relate to things like billing cycles, contracting cycles, service needs, current providers, purchase authority, likelihood of making a change from current provider or presently implemented system, etc.

Historically, customer-related information has remained an overlooked business asset that may now become a powerful marketing tool if used properly and in accordance with the teachings disclosed herein. Creating and utilizing an accurate multifaceted profile may allow a company to learn a great deal more about its customers, their business characteristics, and buying patterns. By applying this knowledge, a company may better identify and focus its efforts on businesses that represent the most compelling targets.

By targeting good customers and prospects, a company may avoid wasting money and time on low-potential markets. In addition to better prioritizing sales efforts, other entities and organizations could also make use of the teachings disclosed herein. For example, a customer services department may benefit from a system that incorporates some of the teachings disclosed herein.

From a high level, a method incorporating teachings of the present disclosure may include identifying a plurality of end users, which may be current or potential customers. In practice, each of the plurality of end users may be purchasing one or more telecommunication services from one or more providers. A multifaceted profile for each of the plurality of end users may be maintained in an accessible memory, and each of the respective multifaceted profiles may include at least one demonstrable characteristic and one presumed characteristic. In some embodiments, the memory may be centralized and maintain all the necessary information. In other embodiments, information may be stored in a collection of remote memories. For example, various portions of relevant customer information may be maintained by finance, accounts receivable, credit, sales, sales promotion, fulfillment, marketing and/or service departments. In such an embodiment, a multifaceted profile for a given end user may include one or more pointers that indicate the location of the stored information.

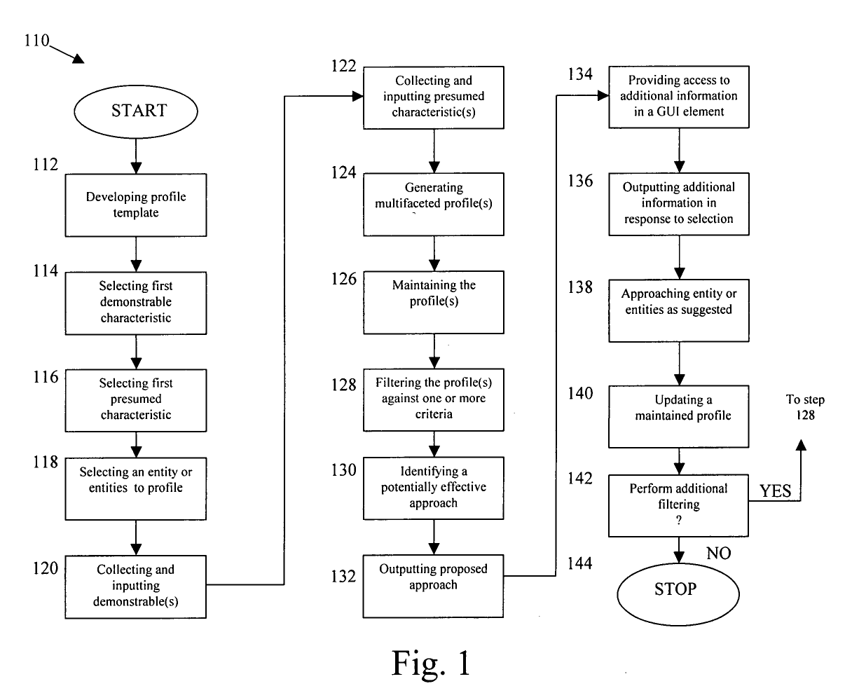

As mentioned above, FIG. 1 presents a flow diagram for an embodiment of a multifaceted customer profiling technique 110 that incorporates teachings of the present disclosure. To-be-profiled entities may be individuals, enterprises, governmental entities, and/or some other entity that utilizes some product or service. In one embodiment, the service may represent a telecom service like Long Distance, Voice over Internet protocol (VoIP), a managed network service, and/or a telecom backhaul service like frame relay services, DSL services, cable services, optical networking services, and dedicated T1 services.

Whatever the relevant product or service, a predefined profile template may be developed at step 112. In practice, the template may include fields to be populated for each entity being profiled. Defining to-be-included information upfront may facilitate the timely gathering of relevant information and, as such, may shorten the time to launch of a system that utilizes multifaceted entity profiles. At step 114, a demonstrable characteristic may be selected for the profile template. In some cases, the template may actually include several demonstrable characteristics for each profiled entity. The demonstrable characteristics may include, for example, each of a physical address for the first customer, a Data Universal Numbering System number, a unique customer identifier, a range indicating a number of first customer employees, a number of office locations for the first customer, an indicator of an annual revenue of the first customer during a previous year, and an indicator of payments received from the first customer during a previous time period.

At step 116, a presumed characteristic may be selected for the profile template. As with the demonstrable characteristics, the template may actually include several presumed characteristics for each profiled entity. The presumed characteristics may include, for example, a current dominant provider of a selected service to the first entity, an indicator of purchase authority available to a representative of the first entity, a typical contract lifecycle for the first entity; and an indicator of how likely the first entity is to leave the current dominant provider, etc.

At step 118, one or more entities may be selected for profiling. At step 120, a process of collecting and inputting the selected demonstrable characteristics may be initiated. The process may be akin to a data entry operation, and may be performed manually and/or in an automated fashion. In some embodiments, fields may be populated with the actual demonstrable characteristic. In other cases, the fields may maintain some mechanism for pointing to or locating the demonstrable characteristic.

At step 122, a similar process may begin for presumed characteristics. In some cases, an account manager or client contact person may be tasked with contacting a to-be-profiled entity to gather the relevant information. However collected and input, the various characteristics may, in some cases, be weighted. For example, a profile may include fields that allow an operator to effectively give a confidence score to an input value. The various inputs characteristics and confidence scores may then be used to generate a multifaceted profile for each entity at step 124.

At step 126, the developed profiles may be maintained in memory. In some embodiments, the profiles will be maintained in a manner and format that allows for searching or filtering of maintained profiles against some criteria, which may or may not be one of the input characteristics. For example, at step 128, a user of a multifaceted profiling system may elect to filter maintained profiles against an input characteristic such as office locations of profiled entities. In some cases, the user may be capable of filtering based on derived criteria. Derived criteria may be one that can be at least partially calculated and/or determined from one or more input characteristics.

Examples of derived criteria may include, for example, an Account Capture Value (ACV) and an Overlap Value. Depending upon implementation detail, an ACV may be calculated by comparing how much an entity spends in total for a class of service versus how much the entity spends with a given service provider for that class of service. If the entity spends a total of one thousand dollars annually for a service and three hundred dollars of that goes to a given service provider, it may be determined that the service provider enjoys an ACV of 30%.

Similarly, if an entity has office locations and/or service needs that overlap with a given providers footprint and/or service offerings, the degree of overlap may be reduced to an Overlap Value. Simplistically, if a provider is capable of meeting 90% of an entity's needs, the Overlap Value may set at 90%.

However filtered, a system implementing technique 110 may identify at step 130 a potentially effective approach to dealing with a selected entity and output the proposed approach at step 132. The proposed approach may have been identified based upon a complex filtering of an entity profile against one or more criteria. In some cases, the output may be in a report format and/or a display format presented within a Graphical User Interface (GUI). Moreover, the proposed approach may be couched as a sales plan, a contact schedule, a suggested marketing campaign, a pricing promotion, etc.

In some embodiments, proposed approaches may have been input into a system implementing technique 110 by an administrator. For example, an administrator may have identified techniques that were effective in the past for a given profile type and set up the system implementing technique 1 10 to output the proven technique when a profiled entity has a multifaceted profile that matches or nearly matches the given profile type. By allowing the administrator to input proven techniques, a system implementing technique 1 10 may effectively assist in the capture of knowledge capital. Moreover, if the system is updateable, an administrator may periodically modify the proposed approaches to be output by the system to occasionally try new techniques in a systematic way.

Whatever the origin of proposed approaches, additional information about a given profile may be made available at step 134. For example, if a proposed approach is included in a display format presented within a GUI, a user may select an icon in the GUI. In response to the selection, additional information about a profiled entity may be presented at step 136. For example, a proposed approach may include calling a contact person at the profiled entity to discuss an upcoming contract renewal process. Selecting an icon associated with the proposed approach may cause the display of the person who is believed to be the correct contact person, her telephone number, personal information about the contact such as children's names, etc., current contract expiration date, etc.

At step 138, a user may approach a profiled entity as suggested and provide feedback indicating how effective the proposed approach proved to be. At step 140, a given profile may be updated and/or a given proposed approach may be modified. At step 142, the need or desire to perform additional filtering may be gauged. If additional filtering is required, technique 110 may progress to step 128. If additional filtering is not required, technique 110 may progress to stop at step 144.

Though the various steps of technique 110 are described as being performed by a specific actor or device, additional and/or different actors and devices may be included or substituted as necessary without departing from the spirit of the teachings disclosed herein. Similarly, the steps of technique 110 may be altered, added to, deleted, re-ordered, looped, etc. without departing from the spirit of the teachings disclosed herein.

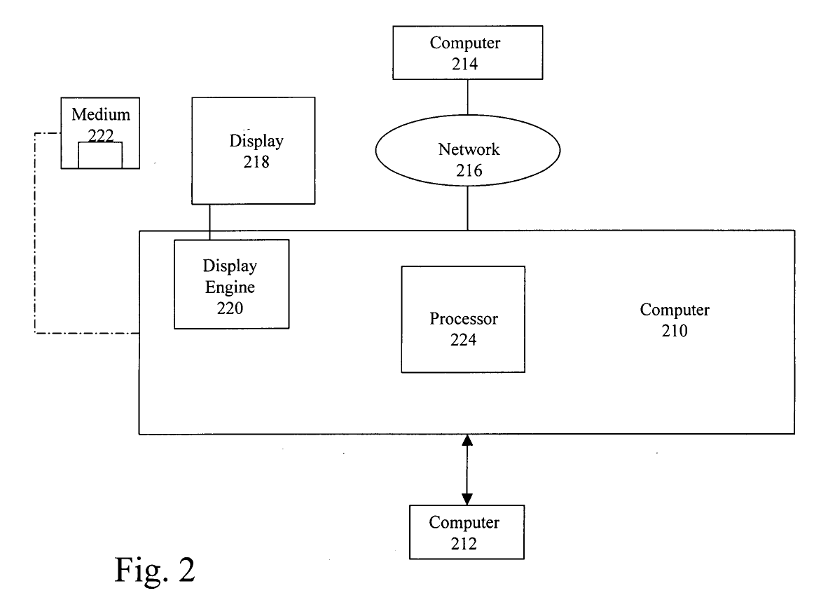

As mentioned above, FIG. 2 presents an illustrative diagram of a user interface system that facilitates the utilization of profile-filtered information in accordance with teachings of the present disclosure. In the embodiment of FIG. 2, a computer 210 may be accessed by a user 212. User 212 may want to create and/or modify customer profiles. User 212 may also want to perform profile filtering on a select group of customers to determine how a given product offering, service offering, pricing promotion, marketing plan, etc. may be received by current, future, past, and/or potential customers. The user may also want to see how to promote such programs.

In one embodiment, to-be-filtered profiles may be maintained at and/or by another computer 214. In practice, computer 214 may be accessible via network 216.

Examples of computer 210 include, but are not limited to, a desktop computer, a notebook computer, a tablet computer, a smart telephone, and a personal digital assistant. Examples of computer 214 include, but are not limited to, a peer computer, a server, and a remote information storage facility. In one embodiment, computer 214 may provide a Web interface via a Web site that provides search functionality and/or other information access and retrieval functionality.

Examples of computer network 216 include, but are not limited to, the Public Internet, an intranet, an extranet, a local area network, and a wide area network. Network 216 may be made up of or include wireless networking elements like 802.11(x) networks, cellular networks, and satellite networks. Network 216 may be made up of or include wired networking elements like the public switched telephone network (PSTN) and cable networks.

As indicated above, a method incorporating teachings of the present disclosure may include providing a graphical user interface (GUI) using computer 210. The GUI may be presented on display 218 and may allow user 212 to view, search, access, sort, modify, create, update, and filter information relating to one or more customers and their respective profiles. The GUI may also allow user 212 to select a given customer identifier, an ACV for the given customer, an opportunity indicator for the given customer and/or some other displayed item by activating a selectable GUI icon.

In response to recognizing activation of a user-selectable icon, an act of initiating a GUI element may be performed. In one embodiment, presentation of a given GUI and/or GUI element may be initiated by a display engine 220. Display engine 220 and/or other described engines may be implemented by, for example, a processor, hardware, firmware, and/or an executable software application.

In operation, computers 210 and 214 may perform several functions. For example, one or both of computers 210 and 214 may facilitate receiving a selection of one or more icons, activating a selectable icon, and initiating presentation of a given element. Moreover, one or both of computers 210 and 214 may assist in maintaining a multifaceted profile for each of a plurality of entities. Depending on implementation detail, each of the multifaceted profiles may include, for example, a respective account capture value (ACV) of a profiled entity and a demonstrable characteristic of the profiled entity.

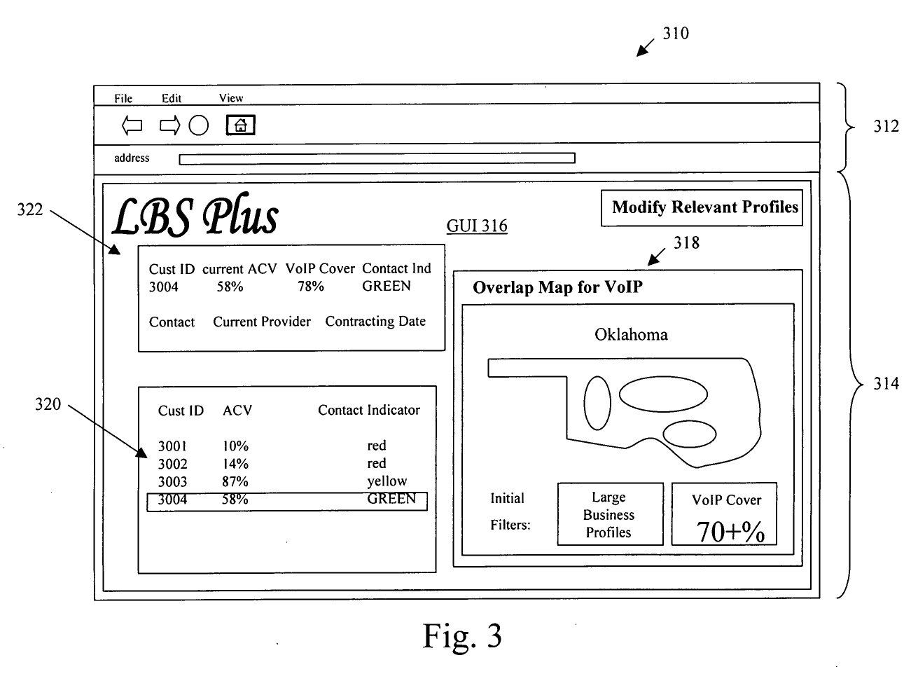

With some information systems, computer 210 may be tasked with performing at least some of relevant functions and, as such, may include a computer readable medium 222 that has instructions for directing a processor like processor 224 to perform those functions. As shown, medium 222 may be a removable medium embodied by a disk, a compact disk, a DVD, a flash with a Universal Serial Bus interface, and/or some other appropriate medium. Similarly, medium 222 may also be an onboard memory made up of RAM, ROM, flash, some other memory component, and/or a combination thereof. In operation, instructions may be executed by a processor like processor 224 that cause display 218 to present user 212 with information about and/or access to one or more profiled entities. One example of a profiling display that may be presented to user 212 is shown in FIG. 3.

As mentioned above, FIG. 3 illustrates one embodiment a display 310 that facilitates the creation and indicates a utilization of a customer profile in accordance with teachings of the present disclosure. As shown, multifaceted profiling display 310 may include a navigation bar portion 312 and a display pane 314. In operation, a computer like computer 210 of FIG. 2 may have a display device capable of presenting a user with a browser or browser-like screen shot of display 310.

As shown, display 310 may include a GUI 316 that represents a filtered output. The embodiment depicted in FIG. 3 shows a multiple window structure for GUI 316. This structure may be presented in several other ways. For example, the display may be presented in a spreadsheet or a row-based format—where, for example, a contact name appears at the head of a row and related information appears in subsequent positions of the same row.

In the depicted embodiment, GUI 316 includes a Modify Relevant Profiles button, an overlap mapping element in window 318, a selected customer break out in window 320, and a more detailed break out for customer 3004 in window 322. In practice, a user may select the Modify button to update, create, modify, etc. available customer profiles.

As depicted, window 318 is presenting an overlap map that includes initial filtering parameters and also indicates portions of the state of Oklahoma in which the user's company is capable of providing a compelling VoIP service offering. As shown, the company's network may not be currently capable of reaching every portion of the state. As the company's capabilities change, the overlap map may be adjusted to reflect the change.

As shown, the user has initially limited the list of to-be-considered profiles to those qualifying as Large Businesses. The threshold value for qualifying as a large business may be modifiable and may be based at least partially on one or more demonstrable characteristics like employee size, number of locations, past annual revenues, etc. The threshold value may also be based at least partially on one or more presumed characteristics.

Window 318 also indicates a filtering criteria of 70% VoIP coverage. In practice, the user may be asking a filtering engine associated with the multifaceted profiling system to output a list of customers that have locations in Oklahoma that allow the company to move at least 70% of the customer's current voice traffic onto a VoIP system. As shown, this first filtering step may have yielded four customers identified in window 320.

Included in window 320 may also be an ACV value and a contact indicator. AS shown, the display of window 320 makes use of a color coded schema to indicate and/or differentiate between, for example, types of approaches. In the depicted embodiment, the combination of 70+% VoIP coverage with an ACV of 58% generates a contact indicator of Green. As shown, the user has hi-lighted and selected customer 3004—causing the display of window 322. Window 322 includes a summary of information about customer 3004 and additional information that may be necessary to effectuate the approach type indicated by the displayed contact indicator. The additional information may include, for example, contact person and information, the current provider of relevant services (which may or may not be competitive), and the contracting date for the relevant services.

It will be apparent to those skilled in the art that the disclosure herein may be modified in numerous ways and may assume many embodiments other than the preferred forms specifically set out and described herein.

Accordingly, the above disclosed subject matter is to be considered illustrative, and not restrictive, and the appended claims are intended to cover all such modifications, enhancements, and other embodiments which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. A method of multifaceted profiling comprising:
selecting a first entity and a second entity;
inputting a demonstrable characteristic for the first entity into a predefined multifaceted profile template;
inputting a different demonstrable characteristic for the second entity into another predefined multifaceted profile template;
inputting a presumed characteristic for the first entity into the predefined multifaceted profile template;
inputting a different presumed characteristic for the second entity into the other predefined multifaceted profile template;
generating a first multifaceted profile for the first entity and a second multifaceted profile for the second entity; and
filtering the first multifaceted profile and the second multifaceted profile against a common criteria.

2. The method of claim 1, wherein the first multifaceted profile comprises a first pointer indicating a first information storage location maintaining an indicator of the demonstrable characteristic and a second pointer indicating a different information storage location maintaining a different indicator of the presumed characteristic.

3. The method of claim 1, wherein the demonstrable characteristic is selected from a group consisting of a physical address, a Data Universal Numbering System number, a unique customer identifier, a number of employees range, a number of office locations range, an indicator of past revenue for the first entity, and a indicator of payments received from the first entity.

4. The method of claim 1, further comprising outputting a report representing the first multifaceted profile and the second multifaceted profile.

5. The method of claim 1, further comprising outputting a sales plan of action based at least in part on an outcome of the filtering step.

6. The method of claim 1, wherein the presumed characteristic is based at least in part on a feedback provided by an individual with account responsibility for the first entity.

7. The method of claim 1, wherein the presumed characteristic is selected from a group consisting of a current dominant provider of a selected service to the first entity, an indicator of purchase authority available to a representative of the first entity, a typical contract lifecycle for the first entity; and an indicator of how likely the first entity is to leave the current dominant provider.

8. The method of claim 1 further comprising periodically updating information maintained in the first multifaceted profile and the second multifaceted profile.

9. The method of claim 1 further comprising scheduling a sales contact with the first entity in response to an outcome of the filtering of the first multifaceted profile against the common criteria.

10. The method of claim 1, wherein the common criteria comprises an account capture value (ACV) that indicates how much of an available budget an entity spends with a selected service provider.

11. A multifaceted profiling system comprising:
a profiling display having a first customer identifier, a second customer identifier, a first account capture value (ACV) that indicates how much of an available budget the first customer spends with a selected service provider, a second ACV that indicates how much the customer spends with the selected service provider, a first opportunity indicator that identifies a proposed approach for increasing the first ACV, and a second opportunity indicator that identifies another proposed approach for increasing the second ACV; and
a graphical user interface (GUI) operable to present the profiling display.

12. The system of claim 11 wherein the first opportunity indicator utilizes a color-coded schema to indicate an approach type.

13. The system of claim 11, wherein the profiling display also comprises a service overlap mapping that indicates an accessibility of the available budget the first customer spends with the selected service provider.

14. The system of claim 11 wherein the first opportunity indicator represents a selectable GUI icon capable of being activated to initiate presentation of additional information about the first customer.

15. The system of claim 11, further comprising a repository maintaining information about a plurality of customers.

16. The system of claim 15, further comprising a filtering engine operable to allow an administrator to perform a structured search of information maintained in the repository.

17. The system of claim 11 further comprising a computing platform communicatively coupled to a computer readable medium that comprises instructions for instructing the computing platform to generate a multifaceted profile for each of the first customer and the second customer, wherein the first customer multifaceted profile includes an indication of the first ACV and a demonstrable characteristic of the first customer.

18. The system of claim 17, wherein the demonstrable characteristic is selected from a group consisting of a physical address for the first customer, a Data Universal Numbering System number, a unique customer identifier, a range indicating a number of first customer employees, a number of office locations for the first customer, an indicator of an annual revenue of the first customer during a previous year, and an indicator of payments received from the first customer during a previous time period.

19. The system of claim 17, further comprising a filtering engine operable to consider the first customer multi-faceted profile in connection with generating the proposed approach for increasing the first ACV.

20. A computer readable media comprising instructions for:
maintaining a multifaceted profile for each of a plurality of entities, wherein each of the multifaceted profiles includes a respective account capture value (ACV) of a profiled entity and a demonstrable characteristic of the profiled entity;
considering a first multi-faceted profile for a first entity in connection with generating a proposed approach for increasing an ACV for the first entity; and
outputting the proposed approach.

21. The media of claim 20, wherein the first multifaceted profile is based at least partially on a user input demonstrable characteristic of the first entity and a presumed characteristic of the first entity.

22. The media of claim 20, wherein the first multifaceted profile is based at least partially on at least two demonstrable characteristics of the first entity and at least two presumed characteristics of the first entity.

23. The media of claim 22, further comprising instructions for accepting a weighting value for at least one of the presumed characteristics.

24. The media of claim 22, wherein at least one of the demonstrable characteristics is selected from a group consisting of a physical address for the first entity, a Data Universal Numbering System number, a unique customer identifier, a range indicating a number of individuals employed by the first entity, a number of office locations for the first entity, an indicator of an annual revenue of the first entity during a previous year, and an indicator of payments received from the first entity during a previous time period.

25. The media of claim 22, wherein at least one of the presumed characteristics is selected from a group consisting of a current dominant provider of a selected service to the first entity, an indicator of purchase authority available to a representative of the first entity, a typical contract lifecycle for the first entity; and an indicator of how likely the first entity is to leave the current dominant provider.

26. The media of claim 20, further comprising instructions for accepting an updating of information represented in the first multifaceted profile.

27. The media of claim 20, further comprising instructions for filtering each of the multifaceted profiles maintained for each of the plurality of entities against a common criteria.

28. The media of claim 27, wherein the common criteria is selected from a group consisting of a location indicator, an ACV threshold, a presumed characteristic included as a field in a predefined multifaceted profile template, and a demonstrable characteristic included as a field in a predefined multifaceted profile template.
